(19) United States
(12) Patent Application Publication
(10) Pub. No.: US 2010/0067645 A1
(43) Pub. Date: Mar. 18, 2010

(54) REFLECTOR SYSTEM OF FAST REACTOR

(75) Inventors: Toshiro SAKAI, Tokyo (JP); Akio TAKAHASHI, Ayase-Shi (JP); Takanari INATOMI, Kawasaki-Shi (JP); Hiroshi NAKAMURA, Hatano-Shi (JP); Masafumi KOMAI, Yokohama-Shi (JP); Mikio IZUMI, Yokohama-Shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/562,815

(22) Filed: Sep. 18, 2009

(30) Foreign Application Priority Data
Sep. 18, 2008 (JP) 2008-239518

(51) Int. Cl. G21C 5/00

(52) U.S. Cl. 376/458

(57) ABSTRACT

A reflector system of a fast reactor according to the present invention comprises a reflector having a neutron reflecting portion reflecting a neutron radiated from a reactor core, and a cavity portion provided above the neutron reflecting portion and having a lower neutron reflecting capacity than a coolant, and a reflector drive apparatus coupled to the reflector and moving the reflector in a vertical direction. The reflector drive apparatus has a driving portion which is coupled to the reflector via a drive shaft, and drives the reflector up and down, and a load sensing portion which is provided between the driving portion and the drive shaft, and senses a load of the reflector. A detecting portion receiving a load signal from the load sensing portion so as to detect a breakage of the cavity portion of the reflector is connected to the load sensing portion.

### BACKGROUND OF THE INVENTION

1. Technology Field

The present invention relates to a reactor system of a fast reactor controlling a reactivity of a reactor core stored in a reactor vessel of the fast reactor filled with a coolant.

2. Background Art

There has been conventionally known a reflector system of a fast reactor controlling a reactivity of a reactor core stored in a reactor vessel of a fast reactor filled with a coolant. The reflector system of the fast reactor comprises a reflector provided so as to be movable in a vertical direction as well as being arranged in an outer side of a peripheral edge of a reactor core, and a reflector drive apparatus coupled to the reflector and moving the reflector in a vertical direction. The reflector has a neutron reflection portion reflecting a neutron radiated from the reactor core, and a cavity portion which is provided above the neutron reflecting portion and having a lower neutron reflecting capacity than the coolant (refer, for example, to Japanese Patent Application Laid-Open No. 2003-35790 and Japanese Patent Application Laid-Open No. 2005-233751).

Among them, the cavity portion of the reflector has a plurality of box-shaped closed vessels, and a gas which is inferior in the neutron reflecting capacity to the coolant is sealed in an inner portion of the closed vessel. Alternatively, the closed vessel is set to a vacuum condition without being filled with the gas. Accordingly, in the case that the cavity portion is arranged so as to be opposed to the reactor core, it is possible to hold down a reactivity of the reactor core in comparison with the case that an outer periphery of the reactor core is covered by the coolant, it is possible to enhance a condensation degree of an atomic fuel and it is possible to elongate a reactivity service life of the reactor core.

However, in the case that the closed vessel of the cavity portion is broken due to a generation of a micro crack by an unexpected matter, the coolant makes an intrusion into the closed vessel little by little. Accordingly, the neutron reflecting capacity of the cavity portion is increased, it becomes hard to control the reactivity of the reflector core, and the reactivity of the reactor core is enhanced so as to cause a reduction of a reactor core service life.

In order to detect the breakage of the cavity portion of the reflector, there is carried out a method of attaching a neutron measuring device to inner and outer sides of a reactor vessel, measuring an amount of neutron in the inner and outer sides of the reactor vessel by the neutron measuring device, evaluating a change-amount of neutron based on the measured data, and detecting presence or absence of the breakage of the cavity portion of the reflector. Further, there is also carried out a method of attaching a temperature measuring device to inner and outer sides of the reactor vessel independently from the neutron measuring device, measuring a temperature in the inner and outer sides of the reactor vessel by the temperature measuring device, calculating a temperature change based on the measured data, and detecting presence or absence of a breakage of the cavity portion of the reflector.

However, a fluctuation of the amount of neutron in the inner and outer sides of the reactor vessel is tiny. Accordingly, it is hard to evaluate the change-amount of neutron so as to detect presence or absence of the breakage of the cavity portion of the reflector. In the same manner, since the change of the temperature in the inner and outer sides of the reactor vessel is tiny, it is also hard to evaluate the change of the temperature so as to detect presence or absence of the breakage of the cavity portion of the reflector. Further, the method of evaluating the amount of neutral or the temperature can be carried out during an operation of the fast reactor, however, cannot be carried out during a shutdown of the fast reactor. Therefore, in the case that the cavity portion of the reflector is broken during the shutdown of the fast reactor, it is difficult to detect the breakage of the cavity portion until the fast reactor starts operating.

In addition, there can be considered a method of filling a tag gas within the closed vessels of the cavity portion of the reflector, providing a detecting portion for detecting the tag gas leaking out of the closed vessel in the case that the closed vessel is broken, and detecting presence or absence of the breakage of the cavity portion. This method has an advantage that it is possible to detect presence or absence of the breakage of the cavity portion even during the shutdown of the fast reactor, however, it is hard to specify the broken closed vessel from a plurality of closed vessels of the cavity portion. Further, in the case of detecting presence or absence of the breakage of the cavity portion by using the tag gas as mentioned above, there is a problem that an equipment of the fast reactor is widely increased and a high cost is necessary.

### SUMMARY

The present invention has been made in view of the above issue, and an object thereof is to provide a reflector system of a fast reactor which can securely detect presence or absence of a breakage of a cavity portion of a reflector.

The present invention is a reflector system of a fast reactor held to a structure body of the fast reactor and controlling a reactivity of a reactor core stored within a reactor vessel of the fast reactor filled with a coolant, the reflector system comprising: a reflector being provided so as to be movable in a vertical direction as well as being arranged in an outer side of a peripheral edge of a reactor core, the reflector having a neutron reflecting portion reflecting a neutron radiated from the reactor core, and a cavity portion provided above the neutron reflecting portion and having a lower neutron reflecting capacity than the coolant; and a reflector drive apparatus coupled to the reflector and moving the reflector in a vertical direction, wherein the reflector drive apparatus has a driving portion which is coupled to the reflector via a drive shaft as well as being supported to the structure body of the fast reactor, and drives the reflector up and down, and a load sensing portion which is provided between the driving portion and the drive shaft, and senses a load of the reflector, a detecting portion receiving a load signal from the load sensing portion is connected to the load sensing portion of the reflector drive apparatus, and the detecting portion evaluates a change-amount between the load based on the load signal transmitted from the load sensing portion and a predetermined load at a time when the reflector is normal, and determines that the cavity portion of the reflector is broken in the case that the change-amount is increased.

The present invention is the reflector system of a fast reactor, wherein the load sensing portion has a load sensor formed as a ring shape.

The present invention is the reflector system of a fast reactor, wherein the load sensing portion has a plurality of load sensors arranged as a ring shape.

The present invention is the reflector system of a fast reactor, wherein the load sensor is constructed by any one of a tension type load sensor sensing a tensile load, and a shear type load sensor sensing a shearing load.

The present invention is a reflector system of a fast reactor held to a structure body of the fast reactor and controlling a reactivity of a reactor core stored within a reactor vessel of the fast reactor filled with a coolant, the reflector system comprising: a reflector being provided so as to be movable in a vertical direction as well as being arranged in an outer side of a peripheral edge of a reactor core, the reflector having a neutron reflecting portion reflecting a neutron radiated from the reactor core, and a cavity portion provided above the neutron reflecting portion and having a lower neutron reflecting capacity than the coolant; and a reflector drive apparatus coupled to the reflector and moving the reflector in a vertical direction, wherein the reflector drive apparatus has a drive cylinder which is coupled to the reflector via a transmission mechanism as well as being supported to the structure body of the fast reactor, and drives the reflector up and down, and a load sensing portion which is coupled between the transmission mechanism and the drive cylinder, and senses a load of the reflector, a detecting portion receiving a load signal from the load sensing portion is connected to the load sensing portion of the reflector drive apparatus, and the detecting portion evaluates a change-amount between the load based on the load signal transmitted from the load sensing portion and a predetermined load at a time when the reflector is normal, and determines that the cavity portion of the reflector is broken in the case that the change-amount is increased.

The present invention is the reflector system of a fast reactor, wherein the load sensing portion is constructed by any one of a compression type load sensor sensing a compressive load, and a shear type load sensor sensing a shearing load.

The present invention is a reflector system of a fast reactor held to a structure body of the fast reactor and controlling a reactivity of a reactor core stored within a reactor vessel of the fast reactor filled with a coolant, the reflector system comprising: a reflector being provided so as to be movable in a vertical direction as well as being arranged in an outer side of a peripheral edge of a reactor core, the reflector having a neutron reflecting portion reflecting a neutron radiated from the reactor core, and a cavity portion provided above the neutron reflecting portion and having a lower neutron reflecting capacity than the coolant; and a reflector drive apparatus coupled to the reflector and moving the reflector in a vertical direction, wherein the reflector drive apparatus has a driving portion which is coupled to the reflector via a drive shaft as well as being supported to the structure body of the fast reactor, and drives the reflector up and down, a strain gauge sensing a strain is attached to the drive shaft or a coupling member coupled between the driving portion and the drive shaft, a detecting portion receiving the strain signal from the strain gauge is connected to the strain gauge, and the detecting portion calculates a load of the reflector based on the strain signal transmitted from the strain gauge, evaluates a change-amount between the calculated load and a predetermined load at a time when the reflector is normal, and determines that the cavity portion of the reflector is broken in the case that the change-amount is increased.

The present invention is a reflector system of a fast reactor held to a structure body of the fast reactor and controlling a reactivity of a reactor core stored within a reactor vessel of the fast reactor filled with a coolant, the reflector system comprising: a reflector being provided so as to be movable in a vertical direction as well as being arranged in an outer side of a peripheral edge of a reactor core, the reflector having a neutron reflecting portion reflecting a neutron radiated from the reactor core, and a cavity portion provided above the neutron reflecting portion and having a lower neutron reflecting capacity than the coolant; and a reflector drive apparatus coupled to the reflector and moving the reflector in a vertical direction, wherein the reflector drive apparatus has a drive cylinder which is coupled to the reflector via a transmission mechanism as well as being supported to the structure body of the fast reactor, the drive cylinder has an output shaft and drives the reflector up and down, a strain gauge sensing a strain is attached to the output shaft of the drive cylinder, a detecting portion receiving the strain signal transmitted from the strain gauge is connected to the strain gauge, and the detecting portion calculates a load of the reflector based on the strain signal transmitted from the strain gauge, evaluates a change-amount between the calculated load and a predetermined load at a time when the reflector is normal, and determines that the cavity portion of the reflector is broken in the case that the change-amount is increased.

The present invention is a reflector system of a fast reactor held to a structure body of the fast reactor and controlling a reactivity of a reactor core stored within a reactor vessel of the fast reactor filled with a coolant, the reflector system comprising: a reflector being provided so as to be movable in a vertical direction as well as being arranged in an outer side of a peripheral edge of a reactor core, the reflector having a neutron reflecting portion reflecting a neutron radiated from the reactor core, and a cavity portion provided above the neutron reflecting portion and having a lower neutron reflecting capacity than the coolant; and a reflector drive apparatus coupled to the reflector and moving the reflector in a vertical direction, wherein the reflector drive apparatus has a driving portion which is coupled to the reflector via a drive shaft as well as being supported to the structure body of the fast reactor, and drives the reflector up and down, and a torque sensing portion which is provided between the driving portion and the drive shaft and senses a torque of the driving portion, a detecting portion receiving the torque signal from the torque sensing portion is connected to the torque sensing portion of the reflector drive apparatus, and the detecting portion calculates a load of the reflector based on the torque signal transmitted from the torque sensing portion, evaluates a change-amount between the calculated load and a predetermined load at a time when the reflector is normal, and determines that the cavity portion of the reflector is broken in the case that the change-amount is increased.

According to the present invention, it is possible to securely detect presence or absence of the breakage of the cavity portion of the reflector by means of the detecting portion by sensing the load of the reflector by means of the load sensing portion, regardless of an operating state and a shutdown state of the fast reactor. Accordingly, it is possible to further improve a reliability of the fast reactor.

### BRIEF DESCRIPTION OF THE DRAWINGS

FIG. 1 is a view showing a whole structure of a fast reactor including a reflector system of the fast reactor in a first embodiment according to the present invention;

FIG. 2 is a view showing a state in which a cavity portion of a reflector is opposed to a fuel assembly, in the reflector system of the fast reactor in the first embodiment according to the present invention;

FIG. 3 is a view showing a state in which the reflector is pulled up with respect to the state in FIG. 2, in the reflector system of the fast reactor in the first embodiment according to the present invention;

FIG. 4 is a view showing details of a reflector drive apparatus of the reflector system of the fast reactor in the first embodiment according to the present invention;

FIG. 5 is a view showing a first load sensor of the reflector system of the fast reactor in the first embodiment according to the present invention;

FIG. 6 is a view showing the first load sensor of the reflector system of the fast reactor in the first embodiment according to the present invention;

FIG. 7 is a view showing a second load sensor of the reflector system of the fast reactor in the first embodiment according to the present invention;

FIG. 8 is a view showing a third load sensor in the first embodiment according to the present invention;

FIG. 9 is a view showing a state in which a plurality of load sensors are arranged as a ring shape in the first embodiment according to the present invention;

FIG. 10 is a view showing details of a reflector drive apparatus of a reflector system of a fast reactor in a second embodiment according to the present invention;

FIG. 11 is a view showing details of a reflector drive apparatus of a reflector system of a fast reactor in a third embodiment according to the present invention; and

FIG. 12 is a view showing a strain torque measuring device of the reflector system of the fast reactor in the third embodiment according to the present invention.

### DETAILED DESCRIPTION

A description will be given below of embodiments according to the present invention with reference to the accompanying drawings.

### First Embodiment

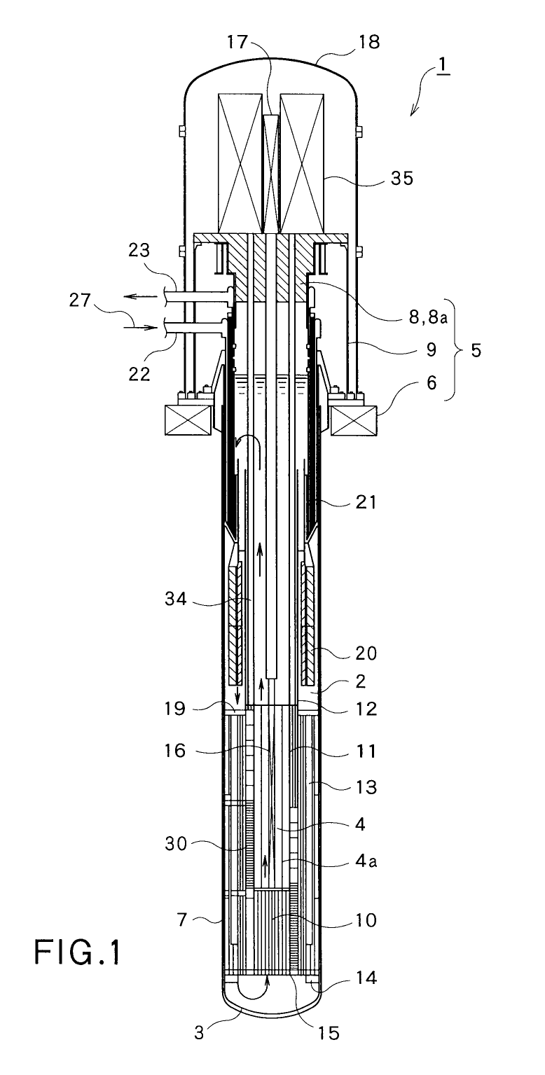

In this case, FIGS. 1 to 9 are views showing a reflector system of a fast reactor in a first embodiment according to the present invention.

First of all, a description will be given of a whole structure of the fast reactor with reference to FIG. 1. As shown in FIG. 1, a fast reactor 1 comprises a reactor vessel 3 which is filled with a primary coolant 2 made of a liquid sodium as well as being held to a structure body 5 (in particular, a pedestal 6 mentioned below) of the fast reactor, and is formed as a closed-end cylindrical shape, and a reactor core 4 which is stored within the reactor vessel 3 and is immersed in the primary coolant 2. Among them, the reactor core 4 has a fuel assembly 4a constructed by a plurality of atomic fuels loaded in an inner portion thereof, and is formed as a cylindrical shape as a whole.

In this case, the fast reactor 1 is a reactor which can be driven continuously for ten and several years to some tens years, for example, about thirty years without exchanging the atomic fuel, and an output thereof is 30 MW to one hundred and some tens MW (ten thousand KW to one hundred and some tens thousand KW in an electric output). Further, a height of a whole of the reactor is between 25 m and 35 m, for example, about 30 m, and a height of a reactor core is, for example, about 2.5 m. A temperature of the coolant may be set to a temperature which is equal to or higher than a temperature at which the liquid sodium is not solidified, and the reactor is operated at 200° C. or higher on the safe side, and preferably at 300° C. to 550° C. Specifically, it comes to 300° C. to 400° C., for example, 350° C., in a coolant flow path within the reactor vessel 3, and comes to 500° C. to 550° C., for example, at 500° C., in the reactor core side.

As shown in FIG. 1, a guard vessel 7 supported to the pedestal 6 is provided in an outer side of the reactor vessel 3, and an outer periphery of the reactor vessel 3 is covered by the guard vessel 7. Further, a shield plug 8 closing the reactor vessel 3 is provided at a top portion of the reactor vessel 3, and the shield plug 8 is constructed by an upper plug 8a, and is supported to the pedestal 6 via a shield plug support table 9. The structure body of the fast reactor is constructed by the shield plug 8, the shield plug support table 9 and the pedestal 6.

A reflector 30 is provided so as to be arranged in an outer side of a peripheral edge of the reactor core 4 and be movable in a vertical direction, and a reactivity of the reactor core 4 is controlled by regulating a leakage of a neutron discharged from the reactor core 4 by moving the reflector 30 in the vertical direction.

A reactor core barrel 11 covering the reactor core 4 is provided between the reactor core 4 and the reflector 30. Further, a partition wall 12 surrounding the reflector 30 is provided in an outer side of a peripheral edge of the reflector 30, and a coolant flow path of the primary coolant 2 is formed between the partition wall 12 and an inner wall of the reactor vessel 3. Further, a neutron shield 13 shielding the neutron discharged from the reactor core 4 is provided between the partition wall 12 and the inner wall of the reactor vessel 3, and shields the neutron discharged while transmitting or bypassing the reflector 30 from the reactor core 4. Further, a reactor core support plate 15 is provided in a lower portion of the reactor vessel 3 via the reactor core support table 14 fixed to the reactor vessel 3, and the reactor core 4, the reactor core barrel 11, the partition wall 12 and the neutron shield 13 are supported onto the reactor core support plate 15. Further, an entrance module 10 through which the primary coolant 2 flowing into the reactor core 4 passes is provided below the reactor core 4 on the reactor core support plate 15.

An upper support plate 19 supporting the reactor core 4 is provided above the reactor core 4. An annularly formed electromagnetic pump 20 is provided above the neutron shield 13 within the reactor vessel 3, above the upper support plate 19, and the primary coolant 2 is circulated as shown by an arrow shown in FIG. 1 by the electromagnetic pump 20.

An intermediate heat exchanger 21 carrying out a heat exchange between the primary coolant 2 and a secondary coolant (not shown) is provided above the electromagnetic pump 20. The primary coolant 2 is flowed into a tube (not shown) side of the intermediate heat exchanger 21, the secondary coolant is flowed to a shell (not shown) side, and the primary coolant and the secondary coolant are configured to be heat exchangeable. In this case, the electromagnetic pump 20 and the intermediate heat exchanger 21 can be integrated or integrally constructed, for example. Further, an inlet nozzle 22 introducing the secondary coolant into the reactor vessel 3 is provided above the intermediate heat exchanger 21, and an outlet nozzle 23 introducing the secondary coolant to an outer side of the reactor vessel 3 is provided. The outlet nozzle 23 is coupled to a vapor generator (not shown). In this case, as a material used for the secondary coolant, the liquid sodium can be used in the same manner as the primary coolant 2.

As shown in FIG. 1, there is provided a reactor shutdown rod 16 which can be taken in and out of the reactor core 4 and shuts down the reactor core, and a reactor shutdown rod drive apparatus 17 moving the reactor shutdown rod 16 in a vertical direction is coupled to the reactor step rod 16. The reactor shutdown rod drive apparatus 17 is installed onto an upper plug 8a constructing the shield plug 8 together with a reflector drive apparatus 35 mentioned below, and is covered by a storage dome 18 fixed onto the pedestal 6.

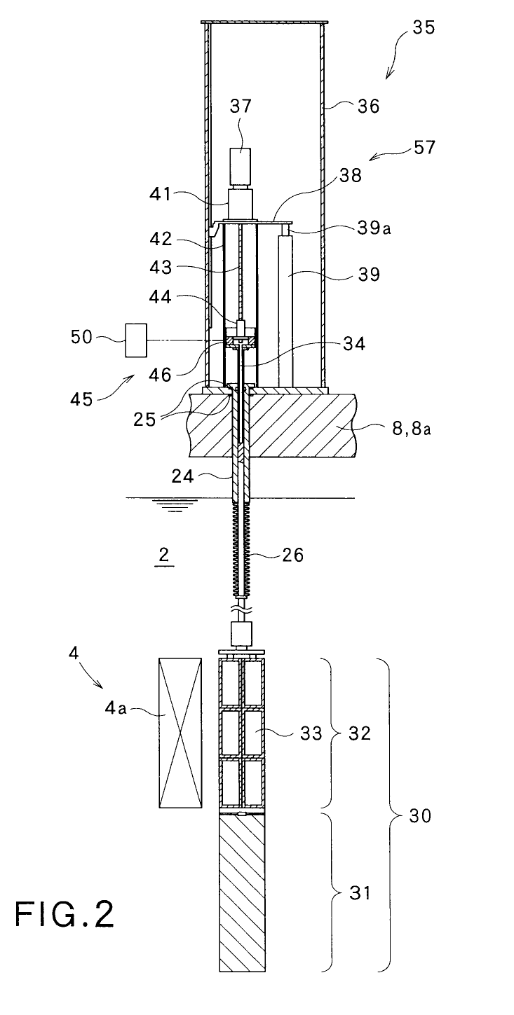

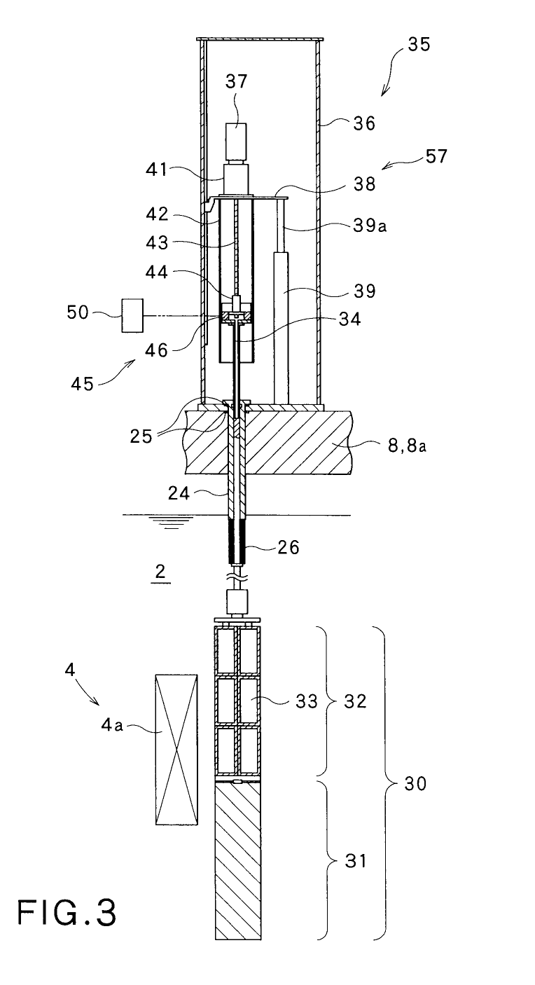

As shown in FIGS. 2 and 3, the reflector 30 has a neutron reflecting portion 31 having a higher neutron reflecting capacity than the primary coolant, and reflecting the neutron radiated from the reactor core 4, and a cavity portion 32 provided above the neutron reflecting portion 31 and having a lower neutron reflecting capacity than the primary coolant 2. A plurality of neutron reflecting portions 31 and cavity portions 32 of the reflector 30 are arranged so as to be aligned in a peripheral direction, are constructed as an approximately cylindrical shape (sleeve shape) or an annular shape as a whole, and are constructed as an independent segment structure which can be divided into several pieces or ten and several pieces in a peripheral direction.

The neutron reflecting portion 31 of the reflector 30 is constructed by a plurality of laminated metal plates (not shown), and the metal plates have a plurality of coolant flow paths (not shown) through which the primary coolant 2 flows.

The cavity portion 32 of the reflector 30 is constructed by a plurality of closed vessels 33, and an inert gas such as helium (He), argon (Ar) or the like which is inferior in a neutron reflecting capacity to the coolant is filled in each of the closed vessels 33. Alternatively, each of the closed vessels 33 may be kept vacuum without being filled with the inert gas. In this case, the closed vessel 33 of the cavity portion 32 may be formed as an optional shape such as a cylindrical shape, a box shape or the like.

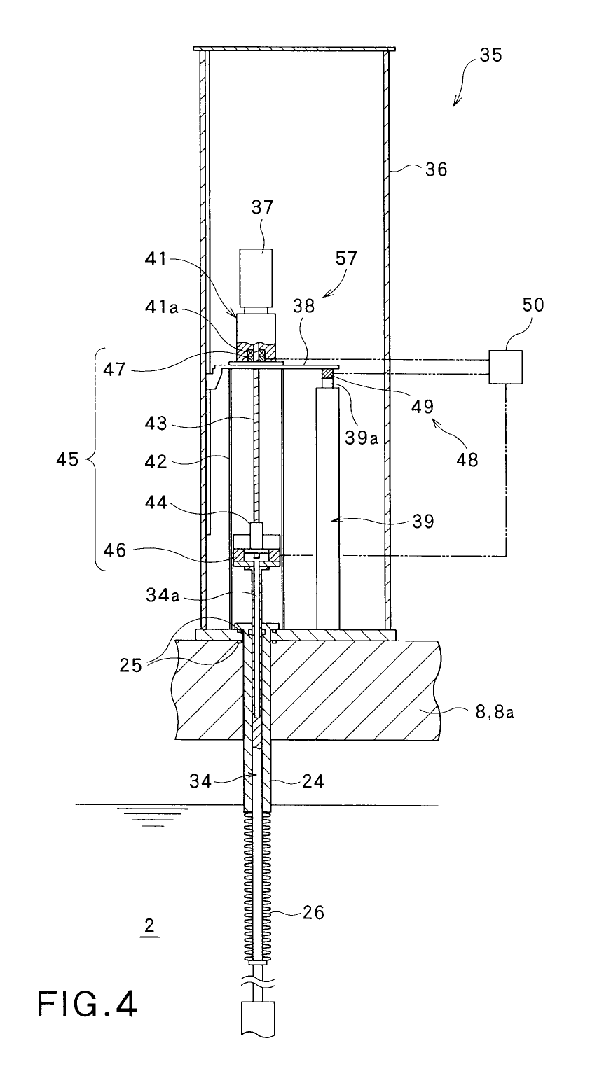

As shown in FIGS. 1 to 3, a reflector drive apparatus 35 is installed on the upper plug 8a constructing the shield plug 8, and the reflector drive apparatus 35 is coupled to the cavity portion 32 of the reflector 30 via a drive shaft 34 and is configured to move the reflector 30 in a vertical direction. Further, the drive shaft 34 has an insertion hole 34a formed in an upper portion of the drive shaft 34, as shown in FIG. 4, and is configured to be capable of inserting a ball nut 43 mentioned below thereto in the case that the reflector 30 is pulled upward. Further, the drive shaft 34 has an end portion 34b formed as a flange shape in its upper end.

As shown in FIGS. 2 to 4, a drive shaft guide 24 guiding the drive shaft 34 is fixed to the shield plug 8 closing the reactor vessel 3, and a seal portion 25 is provided between the drive shaft guide 24 and the shield plug 8, and between the drive shaft guide 24 and an apparatus main body 36 of the reflector drive apparatus 35 mentioned below. Further, one end of an expansion joint 26 is coupled to a lower end of the drive shaft guide 24, and the other end of the expansion joint 26 is coupled to an outer peripheral surface of the drive shaft 34, thereby sealing between an upper side and a lower side of the expansion joint 26 while following to a movement in the vertical direction of the drive shaft 34.

As shown in FIGS. 2 and 3, the reflector drive apparatus 35 has the apparatus main body 36 fixed onto the structure body 5 (in particular, the shield plug 8) of the fast reactor, and an electric motor (a driving portion) 37 which is coupled to the reflector 30 via the drive shaft 34 as well as being supported to the apparatus main body 36, and drives the reflector 30 up and down. Specifically, an attaching table 38 is provided so as to be slidable in a vertical direction with respect to the apparatus main body 36, and the electric motor 37 is fixed onto the attaching table 38. Further, a drive cylinder 39 including an output shaft 39a and vertically driving the reflector 30 independently from the electric motor 37 is fixed to the apparatus main body 36, and an attaching table 38 is coupled to the output shaft 39a of the drive cylinder 39. By means of the drive cylinder 39, the reflector 30 is vertically driven via a transmission mechanism 57 constructed by the drive shaft 34, the electric motor 37 and the attaching table 38.

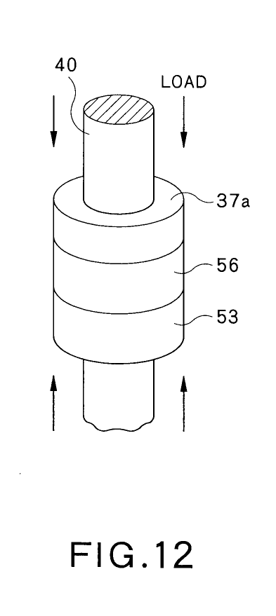

As shown in FIGS. 4 and 7, a reduction gear 41 is coupled to the electric motor 37 of the reflector drive apparatus 35 via a coupling shaft 40 (refer to FIG. 12), the reduction gear 41 has a bearing portion 41a rotatably supporting a support portion 43a of the ball screw 43 mentioned below in its lower portion. A reduction gear side receiving table 52 is interposed between the bearing portion 41a and the attaching table 38, and the reduction gear 41 is configured to be fixed onto the attaching table 38 via the reduction gear side receiving plate 52.

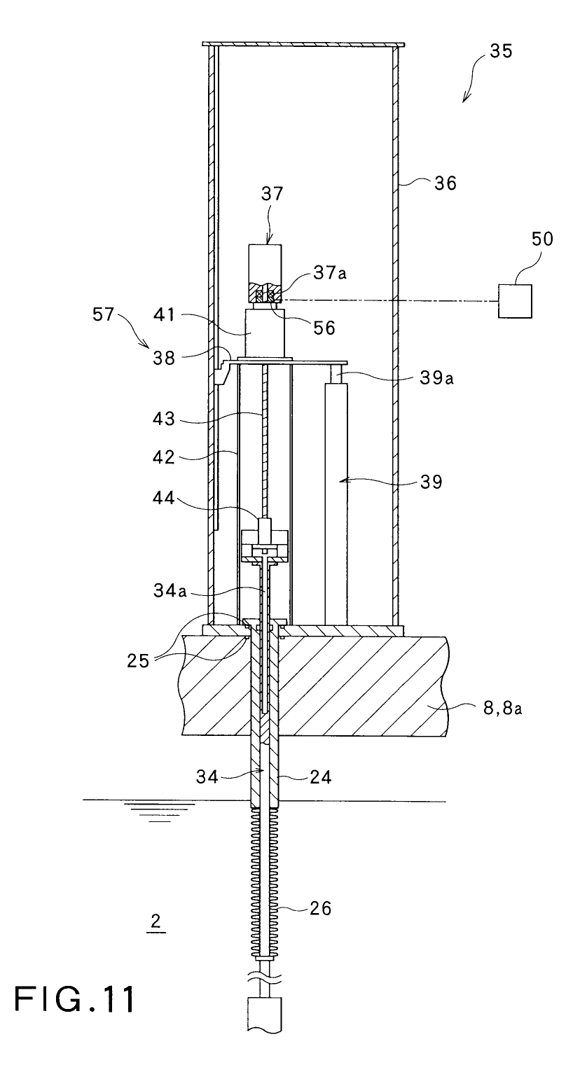

As shown in FIG. 4, the electric motor 37 of the reflector drive apparatus 35 has a bearing portion 37a (refer to FIGS. 11 and 12) rotatably supporting the coupling shaft 40 in its lower portion. An electric motor side receiving table 53 (refer to FIG. 12) is interposed between the bearing portion 37a and the reduction gear 41, and the electric motor 37 is configured to be fixed onto the reduction gear 41 via the electric motor side receiving table 53.

As shown in FIGS. 2 to 4, a cylindrical nut guide 42 is fixed to the attaching table 38 in such a manner as to extending downward, and a ball screw 43 is coupled to the reduction gear 41 in such a manner as to be arranged concentrically with the nut guide 42. The ball screw 43 has a support portion 43a (refer to FIG. 7) formed so as to be supportable by the bearing portion 41a of the reduction gear 41 without forming a screw groove, in its upper portion. Further, a ball nut 44 screwing into the ball screw 43 is provided within the nut guide 42, and the ball nut 44 is configured to be prevented from rotating with respect to the nut guide 42 so as to be slidable with respect to an inner surface of the nut guide 42.

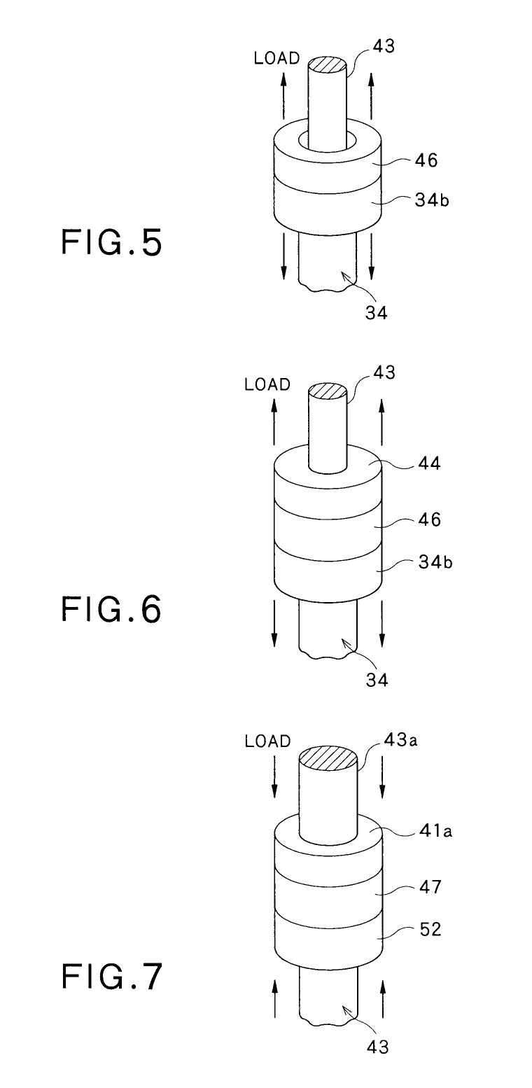

As shown in FIGS. 2 to 4, a first load sensing portion 45 sensing a load of the reflector 30 is provided between the electric motor 37 and the drive shaft 34. In other words, as shown in FIGS. 5 and 6, the first load sensing portion 45 has a first load sensor 46 which is provided between the ball nut 44 and the end portion 34b of the drive shaft 34 and is formed as a ring shape. Since the first load sensor 46 is formed as the ring shape as mentioned above, it is structured such that the ball nut 43 can pass through the first load sensor 46 in the case of pulling the reflector 30 upward by the electric motor 37 of the reflector drive apparatus 35.

As shown in FIGS. 4 and 7, the first load sensing portion 45 has a second load sensor 47 which is provided between the bearing portion 41a of the reduction gear 41 and the reduction gear side receiving table 52 and is formed as a ring shape. As mentioned above, since the second load sensor 47 is formed as the ring shape as shown in FIG. 7, it is configured to pass the support portion 43a of the ball screw 43 through.

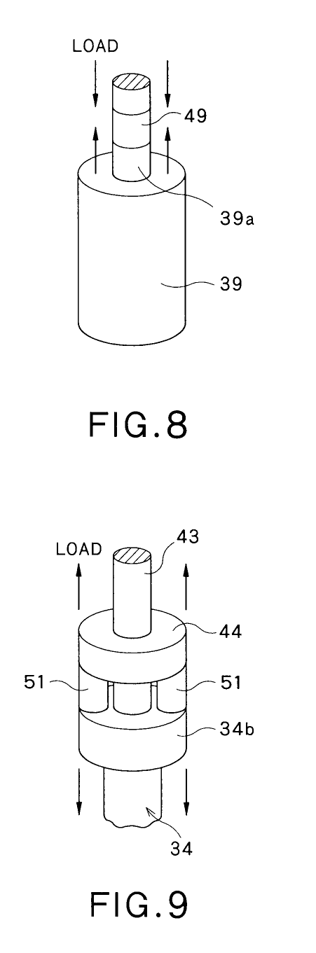

As shown in FIGS. 4 and 8, a second load sensing portion 48 sensing the load of the reflector 30 is provided between the attaching table 38 of the reflector drive apparatus 35 and the output shaft 39a of the drive cylinder 39. Since a compressive load by the reflector 30 is applied to the output shaft 39a of the drive cylinder 39, it is preferable that the second load sensing portion 48 is constructed by a third load sensor 49 comprising of a compression type load sensor sensing a compressive load. In this case, since a shearing load by the reflector 30 is also applied to the output shaft 39a of the drive cylinder 39, a shearing type load sensor sensing a shearing load may be used as the third load sensor 49 in place of the compression type load sensor.

A detecting portion 50 receiving load signals from the first load sensor 46, the second load sensor 47 and the third load sensor 49 is connected to the first load sensor 46 and the second load sensor 47 of the first load sensing portion 45 of the reflector drive apparatus 35, and the third load sensor 49 of the second load sensing portion 48. The detecting portion 50 evaluates change-amounts between each of the loads based on the load signals transmitted from the first load sensor 46, the second load sensor 47 and the third load sensor 49, and the predetermined load at a time when the reflector 30 is normal, and determines that the cavity portion 32 of the reflector 30 is broken in the case that at least one of the change-amounts is increased.

Next, a description will be given of an operation of the present embodiment constructed as mentioned above. First of all, a description will be given of a flow of the coolant in the fast reactor 1 shown in FIG. 1.

First of all, as shown by an arrow in FIG. 1, the primary coolant 2 moves downward between the inner wall of the reactor vessel 3 and the partition wall 12, within the reactor vessel 3 by the driving force of the electromagnetic pump 20. Next, the primary coolant 2 reaches the below of the reactor core support plate 15, passes through the reactor core support plate 15 from the below of the reactor vessel 3 and flows into the reactor core 4 through the entrance module 10 in the lower portion of the reactor core 4. Further, the primary coolant 2 flowing into the reactor core 4 as mentioned above absorbs a heat generated by a nuclear division of the fuel assembly 4a within the reactor core 4, and is heated.

Then, the primary coolant 2 heated within the reactor core 4 moves up in an inner side of the reactor core barrel 11, and reaches the intermediate heat exchanger 21. During this time, as shown in FIG. 1, the secondary coolant (not shown) is flowed into the reactor vessel 3 via the inlet nozzle 22, and reaches the intermediate heat exchanger 21.

Next, the primary coolant 2 and the secondary coolant are heat exchanged within the intermediate heat exchanger 21. In this case, the heat of the heated primary coolant 2 moves to the secondary coolant, and the secondary coolant is heated as well as the primary coolant 2 is cooled. Thereafter, the heated secondary coolant is discharged out of the reactor vessel 3 via the outlet nozzle 23, and is supplied to a steam generator (not shown).

After that, the cooled primary coolant 2 flow into the electromagnetic pump 20 provided below the intermediate heat exchanger 21, and circulates within the reactor vessel 3 by the electromagnetic pump 20.

Next, a description will be given of an operation of the reflector system of the fast reactor in the present embodiment.

First of all, a description will be given of the case that the reflector 30 is moved in the vertical direction by the electric motor 37 of the reflector drive apparatus 35, with reference to FIGS. 2 to 4. In this case, the ball screw 43 is rotated in a desired direction via the reduction gear 41 by the electric motor 37. Accordingly, the ball nut 44 screwing into the ball screw 43 slides in the vertical direction with respect to the nut guide 42, and it is possible to move the reflector 30 in the vertical direction via the drive shaft 34 according to the sliding motion of the ball nut 44.

Next, a description will be given of the case that the reflector 30 is moved in the vertical direction by the drive cylinder 39 of the reflector drive apparatus 35. In the case that the reflector 30 is moved upward by the drive cylinder 39, the attaching table 38 is moved upward by the drive cylinder 39 of the reflector drive apparatus 35. Accordingly, the electric motor 37 and the reduction gear 41 which are fixed onto the attaching table 38 move upward together with the attaching table 38, and it is possible to move upward the reflector 30 which is coupled to the reduction gear 41 via the ball screw 43, the ball nut 44, and the drive shaft 34 (refer to FIG. 3).

On the other hand, in the case that the reflector 30 is moved downward, first of all, the attaching table 38 is moved downward by the drive cylinder 39. Accordingly, the electric motor 37 and the reduction gear 41 which are fixed onto the attaching table 38 move downward together with the attaching table 38, and it is possible to move downward the reflector 30 which is coupled to the reduction gear 41 via the ball screw 43, the ball nut 44 and the drive shaft 34.

Thus, it is possible to hold the reflector 30 at a desired position with respect to the reactor core 4, by moving the reflector 30 in the vertical direction by the electric motor 37 or the drive cylinder 39. In the case that the reflector 30 is moved by the drive cylinder 39, it is possible to make a moving speed of the reflector 30 higher than the case that the reflector 30 is moved by the electric motor 37. Accordingly, in the case of controlling the reactivity of the reactor core 4, the reactor 30 is driven by using the drive cylinder 39, and the reflector 30 can be moved in the vertical direction comparatively rapidly. On the other hand, the drive of the reflector 30 by the electric motor 37 is used in the case of continuously moving up the reflector 30 at an extremely low speed for a long term, for completely burning the atomic fuels of the fuel assembly 4a of the reactor core 4 for a long term.

Incidentally, in the case of enhancing the reactivity of the reactor core 4 in the fast reactor 1, the reflector 30 is moved in the vertical direction by the drive cylinder 39 of the reflector drive apparatus 35 as mentioned above, and the neutron reflecting portion 31 of the reflector 30 is opposed to the fuel assembly 4a in the reactor core 4. In this case, since the neutron reflecting portion 31 has a higher neutron reflecting capacity than the neutron reflecting capacity of the primary coolant 2, the neutron discharged from the reactor core 4 is reflected to the reactor core 4, and it is possible to enhance the reactivity of the reactor core 4.

On the other hand, in the case of lowering the reactivity of the reactor core 4, the reflector 30 is moved in the vertical direction by the drive cylinder 39 of the reflector drive apparatus 35, and the cavity portion 32 of the reflector 30 is opposed to the fuel assembly 4a of the reactor core 4 (refer to FIG. 2). In this case, since the cavity portion 32 has a lower neutron reflecting capacity than the neutron reflecting capacity of the primary coolant 2, the neutron discharged from the reactor core 4 is transmitted, and it is possible to make the reactivity of the reactor core 4 lower.

Thus, by moving the reflector 30 in the vertical direction by means of the drive cylinder 39 of the reflector drive apparatus 35, it is possible to regulate the position of the reflector 30 with respect to the reactor core 4 in order to control the reactivity of the reactor core 4.

During this time, as shown in FIG. 4, the load is sensed in the first load sensor 46 of the first load sensing portion 45 provided between the ball nut 44 and the end portion 34b of the drive shaft 34, and the load signal generated by the sensed load is transmitted to the detecting portion 50. In the same manner, the load is sensed in the second load sensor 47 provided between the bearing portion 41a of the reduction gear 41 and the reduction gear side receiving table 52, and the load signal generated by the sensed load is transmitted to the detecting portion 50. Further, the load is sensed in the third load sensor 49 of the second load sensing portion 48 provided between the attaching table 38 of the transmission mechanism 57 and the output shaft 39a of the drive cylinder 39, and the load signal generated by the sensed load is transmitted to the detecting portion 50.

Next, in the detecting portion 50, the loads based on the load signals which are transmitted respectively from the first load sensor 46, the second load sensor 47 and the third load sensor 49 are stored as the load at the normal time.

Thereafter, after a predetermined time has passed, the load of the reflector 30 is sensed in the first load sensor 46, the second load sensor 47, and the third load sensor 49, and is transmitted as the load signal to the detecting portion 50, and the detecting portion 50 evaluates change-amounts between each of the loads based on the load signals transmitted from the first load sensor 46, the second load sensor 47 and the third load sensor 49, and the previously predetermined and stored load of the reflector 30 mentioned above. In the case that each of the change-amounts is not increased, the cavity portion 32 of the reflector 30 is determined to be normal without being broken.

Incidentally, in the case that the closed vessel 33 is broken due to the micro crack generated by an unexpected matter in the closed vessel 33 of the cavity portion 32 of the reflector 30, the primary coolant 2 makes an intrusion into the closed vessel 33 little by little. In the case that the gas is filled in the closed vessel 33, the gas is going to be discharged according to the intrusion of the primary coolant 2. Accordingly, a buoyancy of the cavity portion 32 is lowered little by little, and the load of the reflector 30 is increased.

In this state, the load sensed by the first load sensor 46 is increased in comparison with the load at a time when the reflector 30 is normal, which is previously evaluated and stored by the detecting portion 50. Accordingly, the change-amount between the load mentioned above and the load at the normal time is increased, and it is determined by the detecting portion 50 that the cavity portion 32 of the reflector 30 is broken. Specifically, the cavity portion 32 is determined to be broken in the case that the change-amount is larger than a predetermined amount. In the same manner, in the case that the change-amount between the load based on the load signal transmitted from the second load sensor 47 and the previously evaluated and stored load at a time when the reflector 30 is normal is increased, the cavity portion 32 of the reflector 30 is determined to be broken. In the case that the change-amount between the load based on the load signal transmitted from the third load sensor 49 and the previously evaluated and stored load at a time when the reflector 30 is normal is increased, the cavity portion 32 of the reflector 30 is determined to be broken. In other words, in the case that the change-amount of the load of the reflector 30 in at least one load sensor of the first load sensor 46, the second load sensor 47 and the third load sensor 49 is increased, the reflector 30 is determined to be broken, by the detecting portion 50.

As mentioned above, according to the present embodiment, it is possible to securely detect presence or absence of the breakage of the cavity portion 32 of the reflector 30 by means of the detecting portion 50, by sensing the load of the reflector 30 by means of the first load sensor 46, the second load sensor 47 and the third load sensor 49, regardless of the operating state or the shutdown state of the fast reactor 1. Accordingly, it is possible to further improve a reliability of the fast reactor 1.

Incidentally, in the present embodiment, the description is given of the example that the loads of the reflector 30 are sensed by the first load sensor 46 provided between the ball nut 44 and the end portion 34b of the drive shaft 34, the second load sensor 47 provided between the bearing portion 41a of the reduction gear 41 and the reduction gear side receiving table 52, and the third load sensor 49 provided between the output shaft 39a of the drive cylinder 39 and the attaching table 38. However, the structure is not limited to this, but at least one load sensor among these load sensors may be provided, and may be configured to sense the load of the reflector 30.

In addition, in the present embodiment, the description is given of the example that the first load sensing portion 45 has the first load sensor 46 formed as the ring. However, the structure is not limited to this, but two load sensors 51 may be arranged as a ring shape (in such a manner as to form a point symmetric with respect to the center of the drive shaft 34) between the ball nut 44 and the end portion 34b of the drive shaft 34, as shown in FIG. 9, in place of the first load sensor 46 formed as the ring shape, so as to be connected respectively to the detecting portion 50. In this case, since a tensile load generated by the reflector 30 is applied to the drive shaft 34, it is preferable that each of the load sensors 51 is constructed by a tension type load sensor sensing the tensile load. In this case, since the shearing load generated by the reflector 30 is also applied to the drive shaft 34, a shearing type load sensor sensing the shearing load may be used as each of the load sensors 51 in place of the tension type load sensor.

In addition, in the present embodiment, the description is given of the example that the second load sensor 47 is provided between the bearing portion 41a of the reduction gear 41 and the reduction gear side receiving table 52. However, the second load sensor 47 is not limited to this, but may be provided between the bearing portion 37a (refer to FIGS. 11 and 12) of the electric motor 37 and the electric motor side receiving table 53.

Further, in the present embodiment, the description is given of the example that the reflector drive apparatus 35 has the electric motor 37 vertically driving the reflector 30, and the drive cylinder 39 vertically driving the reflector 30 independently form the electric motor 37. However, the reflector drive apparatus 35 is not limited to this, but may be configured to have any one of the electric motor 37 and the drive cylinder 39 so as to vertically drive the reflector 30. In other words, in the case that the mechanism for vertically driving the reflector 30 is constructed only by the electric motor 37, the reflector drive apparatus 35 has only the first load sensing portion 45 without having the second load sensing portion 48. On the other hand, in the case that the mechanism for vertically driving the reflector 30 is constructed by the drive cylinder 39, the reflector drive apparatus 35 has only the second load sensing portion 48 without having the first load sensing portion 45. In this case, the transmission mechanism 57 is constructed by the attaching table 38, and a transmission member (not shown) coupling the attaching table 38 to the drive shaft 34 so as to transmit the driving force of the drive cylinder 39, and is structured such that the reflector 30 is vertically driven by the drive cylinder 39.

### Second Embodiment

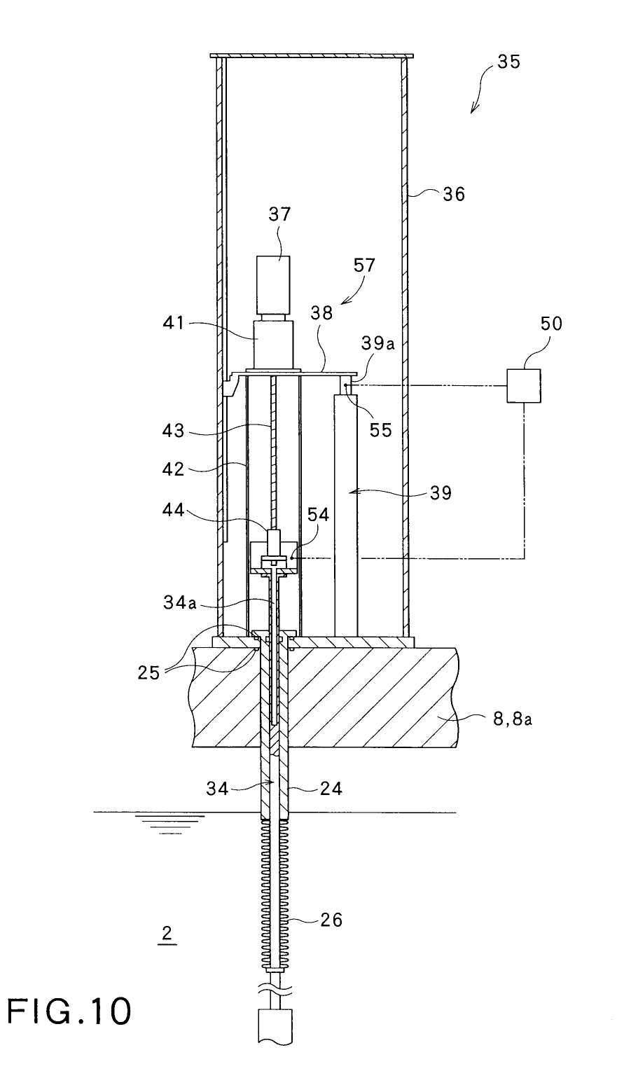

Next, a description will be given of a reflector system of a fast reactor in a second embodiment according to the present invention with reference to FIG. 10.

In the second embodiment shown in FIG. 10, the reflector system of the fast reactor is mainly different in a point that the load of the reflector is sensed by using a strain gauge, and the other structures are approximately the same as the first embodiment shown in FIGS. 1 to 9. In this case, in FIG. 10, the same reference numerals are attached to the same portions as those of the first embodiment shown in FIGS. 1 to 9, and a detailed description will be omitted.

As shown in FIG. 10, a ball nut 44 (a coupling member) is coupled between an electric motor 37 and a drive shaft 34, that is, between a ball screw 43 and the drive shaft 34, and a first strain gauge 54 sensing a strain of the ball nut 44 is attached to the ball nut 44.

A second strain gauge 55 sensing a strain of an output shaft 39a is attached to the output shaft 39a of a drive cylinder 39 of a reflector drive apparatus 35.

A detecting portion 50 receiving strain signals respectively transmitted from the first strain gauge 54 and the second strain gauge 55 is connected to the first strain gauge 54 and the second strain gauge 55. The detecting portion 50 is configured to calculate a load of the reflector 30 based on the strain signals transmitted from the first strain gauge 54 and the second strain gauge 55, evaluate a change-amount between each of the calculated loads, and each of previously predetermined loads at a time when the reflector 30 is normal, and determine that a cavity portion 32 of the reflector 30 is broken in the case that at least one of the change-amounts is increased.

As mentioned above, according to the present embodiment, it is possible to securely detect presence or absence of the breakage of the cavity portion of the reflector 30 by means of the detecting portion 50, by calculating the load of the reflector 30 by means of the detecting portion 50 based on the strain signals from the first strain gauge 54 and the second strain gauge 55, regardless of the operating state or the shutdown state of the fast reactor 1. Accordingly, it is possible to further improve the reliability of the fast reactor 1.

Incidentally, in the present embodiment, the description is given of the example that the load of the reflector 30 is calculated by the detecting portion 50 based on the strain signals form the first strain gauge 54 attached to the ball nut 44 and the second strain gauge 55 attached to the output shaft 39a of the drive cylinder 39. However, the structure is not limited to this, but it may be configured to calculate the load of the reflector 30 by means of the detecting portion 50 by using only one strain gauge of these strain gauges.

In addition, in the present embodiment, the description is given of the example that the first strain gauge 54 is attached to the ball nut 44. However, the first strain gauge 54 is not limited to this, but may be attached to the drive shaft 34.

### Third Embodiment

Next, a description will be given of a reflector system of a fast reactor in a third embodiment according to the present invention with reference to FIGS. 11 and 12.

In the third embodiment shown in FIGS. 11 and 12, the reflector system of the fast reactor is mainly different in a point that the load of the reflector is sensed by using a torque sensing portion, and the other structures are approximately the same as the first embodiment shown in FIGS. 1 to 9. In this case, in FIGS. 11 and 12, the same reference numerals are attached to the same portions as those of the first embodiment shown in FIGS. 1 to 9, and a detailed description will be omitted.

As shown in FIGS. 11 and 12, a strain torque measuring device (a torque sensing portion) 56 sensing a torque of a coupling shaft 40 coupled to a reduction gear 41 is provided between an electric motor 37 and a drive shaft 34, that is, a bearing portion 37a of the electric motor 34 and an electric motor side receiving table 53 in the side of the reduction gear 41.

A detecting portion 50 receiving a torque signal transmitted from the strain torque measuring device 56 is connected to the strain torque measuring device 56. The detecting portion 50 is configured to calculate a load of the reflector 30 based on the torque signal transmitted from the torque measuring device 56, evaluate a change-amount between the calculated load and a previously predetermined load at a time when the reflector 30 is normal, and determine that a cavity portion 32 of the reflector 30 is broken in the case that the change-amount is increased.

As mentioned above, according to the present embodiment, it is possible to securely detect presence or absence of the breakage of the cavity portion 32 of the reflector 30 by means of the detecting portion 50, by calculating the load of the reflector 30 by means of the detecting portion 50 based on the torque signal from the strain torque measuring device 56, regardless of the operating state or the shutdown state of the fast reactor 1. Accordingly, it is possible to further improve the reliability of the fast reactor 1.

Incidentally, in the present embodiment, the description is given of the example that the strain torque measuring device 56 is provided between the bearing portion 37 of the electric motor 37 and the electric motor side receiving table 53 in the side of the reduction gear 41 However, the strain torque measuring device is not limited to this, but may be provided between the bearing portion 41a (refer to FIGS. 4 and 7) of the reduction gear 41 and the reduction gear side receiving table 52 in the side of the attaching table 38 so as to sense the torque of the ball screw 43 coupled to the reduction gear 41 and calculate the load of the reflector 50 by means of the detecting portion 50.

1. A reflector system of a fast reactor held to a structure body of the fast reactor and controlling a reactivity of a reactor core stored within a reactor vessel of the fast reactor filled with a coolant, the reflector system comprising:
a reflector being provided so as to be movable in a vertical direction as well as being arranged in an outer side of a peripheral edge of a reactor core, the reflector having a neutron reflecting portion reflecting a neutron radiated from the reactor core, and a cavity portion provided above the neutron reflecting portion and having a lower neutron reflecting capacity than the coolant; and
a reflector drive apparatus coupled to the reflector and moving the reflector in a vertical direction,
wherein the reflector drive apparatus has a driving portion which is coupled to the reflector via a drive shaft as well as being supported to the structure body of the fast reactor, and drives the reflector up and down, and a load sensing portion which is provided between the driving portion and the drive shaft, and senses a load of the reflector,
a detecting portion receiving a load signal from the load sensing portion is connected to the load sensing portion of the reflector drive apparatus, and
the detecting portion evaluates a change-amount between the load based on the load signal transmitted from the load sensing portion and a predetermined load at a time when the reflector is normal, and determines that the cavity portion of the reflector is broken in the case that the change-amount is increased.

2. A reflector system of a fast reactor according to claim 1, wherein the load sensing portion has a load sensor formed as a ring shape.

3. A reflector system of a fast reactor according to claim 1, wherein the load sensing portion has a plurality of load sensors arranged as a ring shape.

4. A reflector system of a fast reactor according to claim 3, wherein the load sensor is constructed by any one of a tension type load sensor sensing a tensile load, and a shear type load sensor sensing a shearing load.

5. A reflector system of a fast reactor held to a structure body of the fast reactor and controlling a reactivity of a reactor core stored within a reactor vessel of the fast reactor filled with a coolant, the reflector system comprising:
a reflector being provided so as to be movable in a vertical direction as well as being arranged in an outer side of a peripheral edge of a reactor core, the reflector having a neutron reflecting portion reflecting a neutron radiated from the reactor core, and a cavity portion provided above the neutron reflecting portion and having a lower neutron reflecting capacity than the coolant; and
a reflector drive apparatus coupled to the reflector and moving the reflector in a vertical direction,
wherein the reflector drive apparatus has a drive cylinder which is coupled to the reflector via a transmission mechanism as well as being supported to the structure body of the fast reactor, and drives the reflector up and down, and a load sensing portion which is coupled between the transmission mechanism and the drive cylinder, and senses a load of the reflector,
a detecting portion receiving a load signal from the load sensing portion is connected to the load sensing portion of the reflector drive apparatus, and
the detecting portion evaluates a change-amount between the load based on the load signal transmitted from the load sensing portion and a predetermined load at a time when the reflector is normal, and determines that the cavity portion of the reflector is broken in the case that the change-amount is increased.

6. A reflector system of a fast reactor according to claim 5, wherein the load sensing portion is constructed by any one of a compression type load sensor sensing a compressive load, and a shear type load sensor sensing a shearing load.

7. A reflector system of a fast reactor held to a structure body of the fast reactor and controlling a reactivity of a reactor core stored within a reactor vessel of the fast reactor filled with a coolant, the reflector system comprising:
a reflector being provided so as to be movable in a vertical direction as well as being arranged in an outer side of a peripheral edge of a reactor core, the reflector having a neutron reflecting portion reflecting a neutron radiated from the reactor core, and a cavity portion provided above the neutron reflecting portion and having a lower neutron reflecting capacity than the coolant; and
a reflector drive apparatus coupled to the reflector and moving the reflector in a vertical direction,
wherein the reflector drive apparatus has a driving portion which is coupled to the reflector via a drive shaft as well as being supported to the structure body of the fast reactor, and drives the reflector up and down,
a strain gauge sensing a strain is attached to the drive shaft or a coupling member coupled between the driving portion and the drive shaft,
a detecting portion receiving the strain signal from the strain gauge is connected to the strain gauge, and
the detecting portion calculates a load of the reflector based on the strain signal transmitted from the strain gauge, evaluates a change-amount between the calculated load and a predetermined load at a time when the reflector is normal, and determines that the cavity portion of the reflector is broken in the case that the change-amount is increased.

8. A reflector system of a fast reactor held to a structure body of the fast reactor and controlling a reactivity of a reactor core stored within a reactor vessel of the fast reactor filled with a coolant, the reflector system comprising:
a reflector being provided so as to be movable in a vertical direction as well as being arranged in an outer side of a peripheral edge of a reactor core, the reflector having a neutron reflecting portion reflecting a neutron radiated from the reactor core, and a cavity portion provided above the neutron reflecting portion and having a lower neutron reflecting capacity than the coolant; and
a reflector drive apparatus coupled to the reflector and moving the reflector in a vertical direction,
wherein the reflector drive apparatus has a drive cylinder which is coupled to the reflector via a transmission mechanism as well as being supported to the structure body of the fast reactor, the drive cylinder has an output shaft and drives the reflector up and down,
a strain gauge sensing a strain is attached to the output shaft of the drive cylinder,
a detecting portion receiving the strain signal transmitted from the strain gauge is connected to the strain gauge, and
the detecting portion calculates a load of the reflector based on the strain signal transmitted from the strain gauge, evaluates a change-amount between the calculated load and a predetermined load at a time when the reflector is normal, and determines that the cavity portion of the reflector is broken in the case that the change-amount is increased.

9. A reflector system of a fast reactor held to a structure body of the fast reactor and controlling a reactivity of a reactor core stored within a reactor vessel of the fast reactor filled with a coolant, the reflector system comprising:
a reflector being provided so as to be movable in a vertical direction as well as being arranged in an outer side of a peripheral edge of a reactor core, the reflector having a neutron reflecting portion reflecting a neutron radiated from the reactor core, and a cavity portion provided above the neutron reflecting portion and having a lower neutron reflecting capacity than the coolant; and
a reflector drive apparatus coupled to the reflector and moving the reflector in a vertical direction,
wherein the reflector drive apparatus has a driving portion which is coupled to the reflector via a drive shaft as well as being supported to the structure body of the fast reactor, and drives the reflector up and down, and a torque sensing portion which is provided between the driving portion and the drive shaft and senses a torque of the driving portion,
a detecting portion receiving the torque signal from the torque sensing portion is connected to the torque sensing portion of the reflector drive apparatus, and
the detecting portion calculates a load of the reflector based on the torque signal transmitted from the torque sensing portion, evaluates a change-amount between the calculated load and a predetermined load at a time when the reflector is normal, and determines that the cavity portion of the reflector is broken in the case that the change-amount is increased.
